(19) United States
(12) Patent Application Publication
(10) Pub. No.: US 2013/0144671 A1
(43) Pub. Date: Jun. 6, 2013

(54) System and method for advising and investing in companies

(71) Applicant: Hiwot Nega, New York, NY (US)

(72) Inventor: Hiwot Nega, New York, NY (US)

(21) Appl. No.: 13/694,250

(22) Filed: Nov. 13, 2012

Related U.S. Application Data
(60) Provisional application No. 61/559,465, filed on Nov. 14, 2011.

(51) Int. Cl. G06Q 10/06; G06Q 40/00

(52) U.S. Cl. CPC G06Q 10/0635; G06Q 10/06311; G06Q 40/00
USPC 705/7.13; 705/35

(57) ABSTRACT

A method for providing risk management services to company is disclosed. The method involves the following steps: (a) accessing a system; (b) viewing a project posting uploaded to the system; and (c) responding to the project posting in a manner which enables risk management services to be provided to a company.

### RELATED APPLICATION

This application claims priority to U.S. Provisional Application No. 61/559,465, filed Nov. 14, 2011, the subject matter of which is hereby incorporated by reference in its entirety.

### FIELD OF THE INVENTION

The present invention relates to a digital platform and related methods for providing certain strategic advisory and private equity capital to small and mid-size companies.

### BACKGROUND

Many businesses can benefit from access to professional risk management advisory services and long term private equity capital during various stages of their life cycle. Such services and capital resources help businesses compete effectively, pursue long term growth opportunities, gain liquidity for various reasons including succession planning while they continue to build their business.

Unfortunately, it is extremely difficult for smaller companies (generally under $500 million in revenues) to secure an appropriate partner for capital or professional risk management services. This is at least partly due to the fact capital markets have become increasingly short term while high caliber professionals with the required training and expertise are generally not affordable or efficiently accessible to smaller companies. The highly decentralized nature of the small to midsize market and the competition for such talent from big businesses and global markets exacerbates the issue.

To access capital, most small to mid-size companies have to be chosen to participate in private auctions conducted by intermediaries who auction businesses to private equity firms for a fee. For the select small companies that are chosen to participate in an auction and receive investment capital (less than 5%), what seems to be good fortune often can turn into a curse because of large fees charged by investors to the companies after such transaction is consummated. The misalignment of interests between the private equity firms seeking short-term profits and the owners/managers of the companies who are often interested in continuing to build their business for the long-term is another big problem. Often, these conflicts result in diminished company value, job loss and/or dissatisfaction for owners as decisions the private equity investors make squeeze the company for short term gains sacrificing long term value building activities such as R&D, product development and increasing risks for the company after the private equity investors exit their investment in 3-5 years. In sum, the goals and objectives of the private equity firms focused primarily on short-term gains continues to run counter to the goals and objectives of company owners, especially with increased competition and the proliferation of intermediaries that add more costs and risks to the process and ultimately to the companies.

For small to mid-size businesses, the inventor has realized the importance of and value in separating the advisory services from private equity capital. Typically, private equity capital is invested and then risk management services are provided after an ownership relationship is established. The inventor has discovered that independent of private equity capital, providing investment industry expertise and risk management components can drive value for business owners and be a highly valuable catalyst to unlock a company's potential. Additionally, investors benefit from the inventor's process by having access to mutual diligence and being able to take advantage of a risk management process that allows a longer term investment partnership. Moreover, the inventor's process of accessing investment opportunities through a service relationship can cut costs associated with intermediaries and auctions for both companies and investors.

The present invention provides a web-based platform and related methods for providing a risk management and related advisory and/or investment services to small to mid-size companies at low cost. The method allows pre-qualified investment professionals, risk management professionals and business operators who generally work with larger companies or investment firms to work flexibly and directly with small to mid-size companies. The present invention allows small to mid-size businesses to receive efficient, owner-friendly, risk management services from a large network of qualified professionals who previously have not been accessible to the small to midsize market.

### SUMMARY OF THE INVENTION

In a non-limiting embodiment, the present invention is a method for providing risk management services to a company comprising the following steps: assigning one or more risk management professionals to a company, both the risk management professional(s) and the company are registered entities on a system, whereby the assigned risk management professional(s) performs a task(s) for the company in a manner which enables risk management services to be provided to the company.

In another non-limiting embodiment, the present invention is a method for providing risk management services to a company comprising the following steps: (a) accessing a system; (b) viewing a project posting uploaded to the system; and (c) responding to the project posting in a manner which enables risk management services to be provided to a company.

In yet another non-limiting embodiment, the present invention is a method for providing capital to a company comprising the following steps: (a) accessing a system; (b) viewing a request for capital uploaded to the system; and (c) responding to the request for capital in a manner which enables capital to be provided to a company.

### DESCRIPTION OF THE INVENTION

The present invention is web-based, platform and related methods for providing risk management advisory and/or investment services to small and mid-size companies.

In a non-limiting embodiment, the present invention is a method for providing risk management services to a company comprising the following steps: assigning one or more risk management professionals to a company, both the risk management professional(s) and the company are registered entities on a system, whereby the assigned risk management professional(s) performs a task(s) for the company in a manner which enables risk management services to be provided to the company.

The system, risk management professionals, companies, etc. are described later in the specification.

In the abovementioned embodiment, the system evaluates the information it contains for one or more professionals and forms the risk management team for the company prior to any risk management service being provided. The system of the present invention allows a company to evaluate the team assigned to it by the system. If necessary, the company can object to its team potentially leading the system to re-evaluate and re-configure the assigned team. Using the system of the present invention, a company can request one or more registered professionals be added to a team.

In another non-limiting embodiment, the present invention is a method for providing risk management services to a company comprising the following steps: (a) accessing a system; (b) viewing a project posting uploaded to the system; (c) and (c) responding to the project posting in a manner which enables risk management services to be provided to a company.

The described system is open to different types of entities including risk management professionals, which include investment and operating professionals, small to mid-size companies and investors. Before an entity can access the system, the entity must complete a registration and screening process. Generally, the registration process involves completing an online questionnaire, uploading relevant information, etc. After registration is complete, the entity is registered on the system and can create a personal activity page.

The specifics of the registration process will differ depending on the specific type of entity. In other words, the registration process may be slightly different depending on whether an entity is a risk management professional, a small to mid-size company or an investor.

After the registration process is complete, the system assigns a system identifier to the entity which may not related to its actual name. The system identifier is used for communications from and to the entity registered on the system. The system identifier enables communications and projects to be completed in an anonymous and confidential fashion. The anonymity on the system provides an environment within which registered entities can fully share information in a bias free environment while protecting confidential information consistent with the goal of long-term improved performance for all registered entities.

If the entity is a small to mid-size company, the questionnaire can cover information including but not limited to the following: the company's core products, people, milestones, key markets, competition, ambitions, economic model, information about the company, the industry the company operates in, the competition, risks and opportunities to grow the company value in the short and long-term, current plan for the company from the long and short-term perspective, the activities and resources needed to implement the plan, etc.

As part of the registration process and afterward, the company can add relevant information about itself to an activity page. For example, a company can upload the following: ongoing management discussions and analysis on operating and industry risks and opportunities, financial statements including profit and loss, balance sheet and cash flow, etc. Typically, the system will contain the following information about a company: their specific industry, revenue size, founding year, location and other similar data that can help in organizing resources and information. Similar companies may be tagged with other similar companies.

If the entity is a risk management professional (also referred to as a “professional” herein), he/she will answer various questions as part of a screening process designed to help evaluate specific investment, industry and management expertise as well as personality tests required to engage in a disciplined, action and performance oriented risk management process. The questionnaire might also test the professional's long-term orientation, honesty, temperament and other human elements required from a long-term partner. The system may assign a rank to the professional based on the various criteria for matching purposes.

Various types of professionals can provide risk management services according to the present invention. The professionals include industry analysts, operating executives (retired or active) and business experts with functional or industry knowledge such as finance, business development, supply chain, legal or other related functions of building a business. Professionals can also include people who can temporarily engage in special projects to help the company implement strategic or other risk management advice by filling talent gap the company has internally to address risk management priorities such as independent strategic or management consultants.

As part of the registration process and afterwards, the professional can upload information to an activity page. Uploaded information may concern markets, industry and relevant topics to provide a fuller view of the individual's capabilities or to provide advice or share expertise on a given risk management topic.

If the entity is an investor, the questionnaire will attempt to capture relevant information. And the investor will have an opportunity to upload other information of his/her choosing onto an activity page.

As described, the system of the invention includes information about small to mid-size companies, investment professionals, investors, etc. registered on the system. The system of the invention may collect all uploaded information from various entities and may distribute it to other entities according to privacy specifications, type of information and roles of the various professionals. All of the information present on the system may be searchable by an entity based on access permissions the system may assign to that entity. For example, a company could search for professional(s) that may be visible to that company based on the system's permission setting based on the professional's background and interest fit and conflict of interest clearances. Search may be conducted by his/her professional ID, location, industry, functional expertise, and other key search criteria. Similarly, the system may prevent a company or other entity from searching for certain information on the system based on accessibility protocols programmed into the system.

According to the present invention, when a company is in need of certain risk management services, it can initiate the method for providing risk management services according to the present invention by uploading or posting a request on the system. The specific risk management services requested by the company will be in the form of a project posting. Project postings can be private or public. Public project postings can generally be seen and accessed by most registered professionals. Based on accessibility protocols, the system can restrict private project postings so that they can only be viewed by select professionals that may have been tagged by the system as specific resource for the company.

The system can provide or restrict access to certain project postings to a professional(s) registered on the system according accessibility rules based on various criteria like licenses and certifications, years of experience, conflict of interest etc. The company can override the accessibility rules implemented by the system. According to the present invention, the system can also identify professionals that fit the requirements of the project posting and send a request(s) to one or more professionals that they respond to a project posting.

Using the system, a company can search for a professional(s) or a professional(s) may be referred to it by the system based on fit, conflict clearance, etc. Typically, the system contains the following information about registered professionals: their specific industry, management and analytical acumen, professional background and interest, personality, location, time commitment, etc.

Typical risk management project postings relate to the following: diagnosing a business, developing a value generating plan, setting priorities and actions for implementation of the plan, monitoring the implementation of the plan, measuring business improvement and performance after implementation of plan, and adjusting the plan and the associated risk management professional resources for ongoing market developments on a continuous basis. Additionally, a risk management project posting may include a special project request by the company seeking help in actually implementing a plan or advice given to the company on any of the above described risk management activities due to temporary gaps in the company's management team.

A company's activity page may contain information about its project postings. For example, a company's activity positing may be viewable to professionals and categorized by project type, duration, etc.

According to the present invention, professionals can view, respond to and finalize engagements to complete one or more tasks associated with a project posting.

A professional can respond to a project posting in a myriad of ways including by expressing interest by sending an email or posting information on an activity page. Generally, after responding to a project posting, a professional(s) will have to receive a subsequent notification from a company indicating that he/she has been engaged for a project posting before the professional(s) can begin the tasks necessary to complete a project posting. The system enables information to be exchanged between a company and a professional(s) so that the terms of an engagement can be reached and mutually agreed upon.

A professional(s) engaged to complete a task(s) associated with a project posting are granted access by the system to the company's information, can submit work files and can perform other functions in support of the professional's role. A work file may include an analysis file, specific solution or advice on a given problem etc. A formulated plan can also be created by one or more professional participants. And the formulated plan can be executed through various advisory events.

In many instances, a team of risk management professionals will be required to adequately address a project posting. The system has capabilities which allow a group of professionals to apply for and be approved to join a risk management team to complete a project posting. Additionally, using the system, one or more professionals can invite other professionals to join a team subject to screening and approval by the system. The system can allow professionals to selectively and confidentially share information with other professionals on the same team.

When forming a team, a professional(s) may choose to view the profile information of one or more other professionals registered on the system. The system of the present invention can enable a professional(s) to be seen by other related professionals based on their skill background, interest, location and other criteria to facilitate the formation of teams. Professionals can adjust their privacy settings to restrict access to their profiles, etc.

For project postings related to special projects such as, but not limited to, when a company uploads a project posting to fill temporary management gaps to aid in implementing risk management advice, the system of the invention can enable a company to directly evaluate responses and ultimately engage one or more of professionals to complete the project posting. For this type of engagement, certain information about the engagement can be posted on the entities' activity page.

Similar to what has been stated previously, various entities involved in a risk management service engagement or a special project engagement can make documents accessible or non-accessible via the system to other entities participating in an engagement based on confidentiality etc.

After and/or during an engagement, the present invention can allow a company to rate professionals. Similarly, the system can allow a professional to rate a company. The system can use such rankings for continuous improvement of the system for all users and achievement of its objectives.

As engagements are entered into and completed, the system may update the activity pages of the involved entities. For example, when professionals are approved to participate in risk management services, a list of such professionals can become visible as risk management professionals in the company's pages. Similarly the company can be recorded in the professionals' activity page as a risk management project.

The system of present invention can allow sharing and communication exchange between various entities for a certain finite period of time (i.e., until a project posting has been completed, etc.). For example, a risk management professional with a specific expertise in managing risks with a company's manufacturing may be connected with the company for the duration of the risk management service where the topic is manufacturing. Such professional may be disconnected from the company if the risk management topic is moved to another risk management topic such as market expansion. Professionals can access company information for one or more risk management topics based on confidentiality settings and sensitivity of information. The system can organize the various risk management topics for the company and can connect risk management professionals continuously or for a short duration based on the type and duration of the risk management topic. Similarly, as engagements are entered into and completed for special projects, the system may update the activity pages of the involved entities. For example, when professionals are selected to complete a specific project, a status update such as estimated start date, hours, etc. may be posted on their activity page.

According to the present invention, the method for providing risk management services is often provided to a company in advance of investment decisions. In this manner, owners of small to mid-size companies are able to test the quality of services provided by the system and one or more professionals at a minimal cost before making a more substantial commitment.

Via the system, registered entities can perform various tasks. For example, investment professionals can create industry research reports and can communicate with industry executives on the system to access specific information etc. Operating executives can read the reports of investment professionals to better inform themselves on the latest company information and research so they better advice the company on operating issues they have expertise in etc. Companies can ask questions or view advice on various risk management topic on the system, etc. The system of the present invention can allow various unrelated professionals to work together and build on each other's work without wasting time on gathering information on things that are not in their specialty. For example, executives with manufacturing expertise can quickly be informed about the manufacturing risks of the business through the work of analysts so that they can provide actionable advice on how to mitigate the risk instead of spending time on gathering and analyzing information. Similarly, the system of the present invention can allow companies to benefit from the collaborative effort of a network of professionals who share information, advice and skills on the system but can not be accessible or affordable to be hired by the company on a stand alone basis.

The system of the present invention can allow professionals to request to join a risk management team for one or more companies. Further, risk management advisory professionals can request to join a research team for a company prior to a service engagement is entered into to introduce their skills free or charge. Introducing skills prior to an engagement can allow the professional to be better identified and known by companies that are in the process of determining their service interest.

In yet another non-limiting embodiment, the present invention is a method for providing capital to a small to mid-size business. Specifically, the present invention is a method for providing capital to a company comprising the following steps: (a) accessing a system; (b) viewing a request for capital uploaded to the system; and (c) responding to the request for capital in a manner which enables capital to be provided to a company.

This embodiment functions in the same manner as the embodiment for providing risk management services described above and allows qualified investors to make investments in registered companies seeking to satisfy their liquidity or succession planning needs using the system. The investors get an opportunity to accumulate shares in companies they know and trust outside of an expensive auction process.

The small to mid-size companies may be seeking access to capital to grow owner value by expanding their markets and product offerings. Or, the small to mid-size companies may be seeking to sell shares to access liquidity and monetize part of their business while continuing to build further with a trusted partner with a long-term strategy.

According to the present invention, all registered investors comply with any and all applicable laws of investing in companies. Entities interested in potential investment opportunities can be tagged. Further, priority for a specific investment opportunity can be designated by the system according to select criteria such as, for example, the amount of capital an investor is willing to commit or timing of commitment.

At certain times, registered risk management professionals may be interested in becoming an investor providing capital to a particular company they have been working with. Using the system, investment professionals can indicate their interest to provide capital to registered companies as they become available. In many instances, an investment professional interested in providing capital to a company has previously provided some type of service to the company.

The system allows selected investors to review various company and other information posted on the system to conduct due diligence cost effectively and transparently. Companies seeking investment may post certain information on their activity pages such as reports around investment activities. Certain due diligence activities desired by investors may take place outside of the system of the invention.

Further, the present invention enables all required steps to be completed in order for a binding investment commitment between a company and an investor to be entered into. Such steps including the sharing of certain financial information and alternate proposals.

As capital investment decisions are made, relevant information may be posted on the activity pages of the involved entities. Following investment in a company, investors will have their activity page updated with all the necessary information on the company they invested in and can follow the performance of the company through the company's pages designed to track performance.

According to the present invention, the method for providing risk management services provided above can be practiced before the steps required to providing capital to a small to mid-size business.

In the present invention as described above, all steps related to posting, viewing, uploading information, etc. are all accomplished via means which are well known in the art. For example, the methods of the present invention could be effectuated using standard computing devices, communication systems like the World Wide Web (WWW), a Wide Area Network (WAN), and other networks, commercially available database systems, etc.

What is claimed:

1. A method for providing risk management services to a company comprising the following steps: assigning one or more risk management professionals to a company, both the risk management professional(s) and the company are registered entities on a system, whereby the assigned risk management professional(s) performs a task(s) for the company in a manner which enables risk management services to be provided to the company.

2. A method for providing risk management services to a company comprising the following steps: (a) accessing a system; (b) viewing a project posting uploaded to the system; and (c) responding to the project posting in a manner which enables risk management services to be provided to a company.

3. The method according to claim 2 where accessing the system comprises completing a registration process.

4. The method according to claim 2 wherein the company has under $500 million in revenues.

5. The method according to claim 2 wherein the project posting relates to diagnosing a business, developing a value generating plan, monitoring the implementation of the plan, measuring performance or adjusting the plan and the associated risk management resources.

6. A method for providing capital to certain companies comprising the following steps: (a) accessing a system; (b) viewing requests for capital uploaded to the system; and (c) responding to the requests for capital in a manner which enables capital to be provided to a company.

7. The method according to claim 6 where accessing the system comprises completing a registration process.

8. The method according to claim 6 wherein the company has under $500 million in revenues.
